(19) United States
(12) Patent Application Publication
(10) Pub. No.: US 2008/0016181 A1
(43) Pub. Date: Jan. 17, 2008

(54) METHOD AND SYSTEM FOR PROVIDING REMOTE MEDIA

(76) Inventors: Erik John Burckart, Raleigh, NC (US); John Paul Cammarata, Wake Forest, NC (US); Gennaro A. Cuomo, Durham, NC (US); Ruth Anne Taylor, Apex, NC (US)

Correspondence Address: DUKE W. YEE, YEE & ASSOCIATES, P.C., P.O. BOX 802333, DALLAS, TX, 75380, US

(21) Appl. No.: 11/457,262

(22) Filed: Jul. 13, 2006

(51) Int. Cl. G06F 15/16

(52) U.S. Cl. 709/219

(57) ABSTRACT

A computer implemented method, apparatus, and computer usable program code for providing media. A determination is made as to whether providing media would aid in providing information to a user in response to a communication session with the user. The media is authorized to be sent to the user based on an authorization of a representative in response to a determination that providing the media would aid in providing information to the user. The flow of the media sent to the user from the media server is controlled after the media has been authorized.

### BACKGROUND OF THE INVENTION

1. Field of the Invention

The present invention relates generally to an improved data processing system and in particular to a computer implemented method and apparatus for managing media. Still more particularly, the present invention is related to a computer implemented method, apparatus, and computer usable program code for providing remote access to information videos on demand during a voice call.

2. Description of the Related Art

Instant messaging is an online chat medium, allowing users to communicate with each other and collaborate in real-time over a network data processing system. Instant messaging is commonly used over the Internet. Instant messaging applications monitor and report the status of users that have established each other as online contacts. This information is typically presented to a user in a window. Instant messaging applications also are often used by users conducting business. By utilizing instant messaging, business users can view each other's availability and initiate a text conversation with colleagues or customers when a desired contact becomes available.

Typically, with instant messaging applications, communications between users are initiated by users selecting the name of the person with whom they desire to communicate. Then, the users type messages in a dialog box in the window and press “send.” These messages appear instantly on the other selected recipient's computer.

Until now, instant messaging has been developed largely for home users but used by home and business users alike. Instant messaging allows an organization to deploy and utilize this “need-to-have” technology in a business setting. Instant messaging systems have become an integral part of customer service communications with remote customers across various locations and centralized call centers. With instant messaging systems, customers may reach a customer service representative “instantly” as compared to other types of messaging systems, such as email.

Frequently, when a customer service representative fields a voice call or an instant messaging service, the customer service representative brings up a digital video, flash presentation, pictures, or other graphic representations in order to help walk a customer through a problem. For example, a customer service representative may use a graphic presentation to walk a customer through troubleshooting a home entertainment system or assembling a mail-order bed. Many times, customer service representatives struggle to accurately describe in words what the customer needs to do, prolonging the call and increasing customer frustration.

### BRIEF SUMMARY OF THE INVENTION

The illustrative embodiments provide a computer implemented method, apparatus, and computer usable program code for providing media. A determination is made as to whether providing media would aid in providing information to a user in response to a communication session with the user. The media is authorized to be sent to the user based on an authorization of a representative in response to a determination that providing the media would aid in providing information to the user. The flow of the media sent to the user from the media server is controlled after the media has been authorized.

### BRIEF DESCRIPTION OF THE SEVERAL VIEWS OF THE DRAWINGS

The novel features believed characteristic of the illustrative embodiments are set forth in the appended claims. The illustrative embodiments, themselves, however, as well as a preferred mode of use, further objectives, and advantages thereof, will best be understood by reference to the following detailed description of an illustrative embodiment when read in conjunction with the accompanying drawings, wherein:

FIG. 1 is a pictorial representation of a network of data processing systems in which the illustrative embodiments may be implemented;

FIG. 2 is a block diagram of a data processing system in which the illustrative embodiments may be implemented;

FIG. 3 is a block diagram depicting typical software architecture for a server-client system in which the illustrative embodiments may be implemented;

FIG. 4 is a block diagram illustrating components used in an instant messaging system in accordance with the illustrative embodiments;

FIG. 5 is a diagram illustrating an exemplary information flow for remotely providing media in accordance with the illustrative embodiments;

FIG. 6 is a flowchart of a process for accessing media in accordance with the illustrative embodiments;

FIG. 7 is a flowchart of a process for providing remote access to media in accordance with the illustrative embodiments; and

FIG. 8 is a flowchart of a process for providing remote access to media in accordance with the illustrative embodiments.

### DETAILED DESCRIPTION OF THE INVENTION

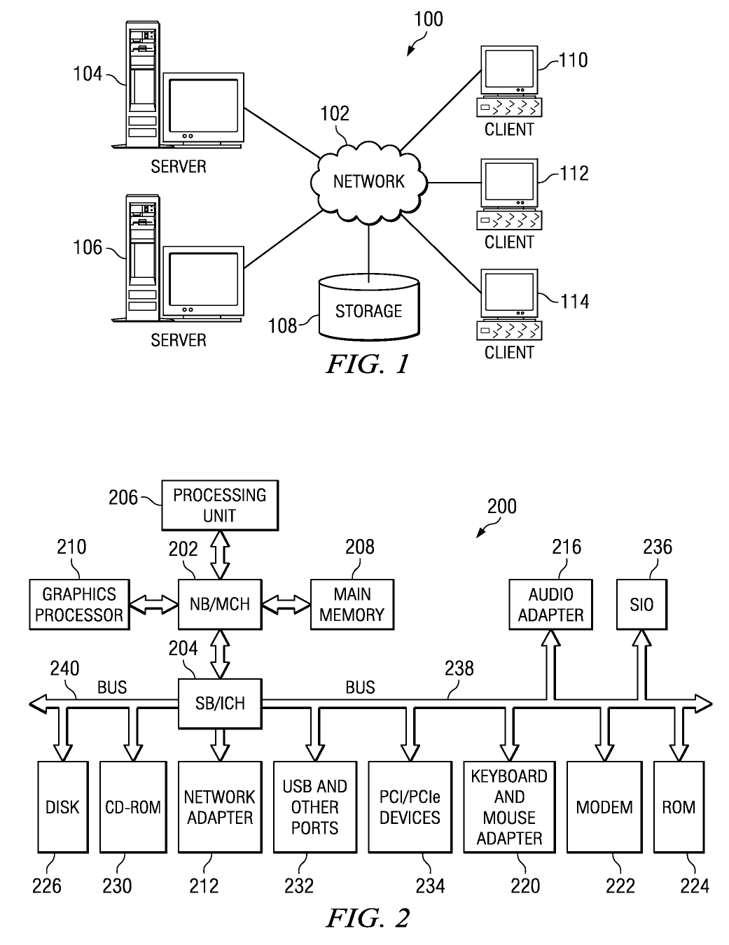

With reference now to the figures, and in particular with reference to FIGS. 1-2, exemplary diagrams of data processing environments are provided in which the illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which the illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which the illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUS. The depicted examples in FIGS. 1-2 and above-described examples are not meant to imply architectural limitations. For example, data processing system 200 also may be a tablet computer, laptop computer, or telephone device in addition to taking the form of a PDA.

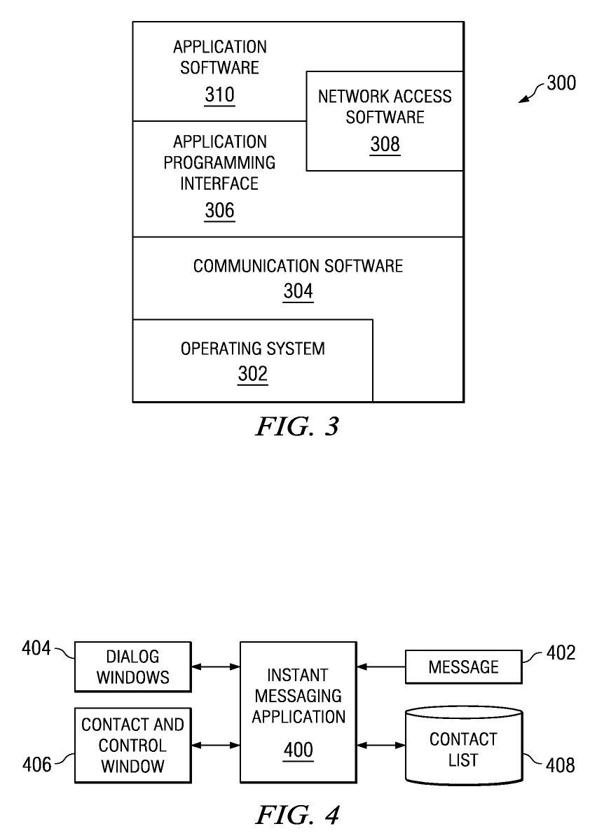

Turning to FIG. 3, typical software architecture for a server-client system is depicted in which the illustrative embodiments may be implemented. At the lowest level, operating system 302 is utilized to provide high-level functionality to the user and to other software. Such an operating system typically includes a basic input/output system (BIOS). Communication software 304 provides communications through an external port to a network such as the Internet via a physical communications link by either directly invoking operating system functionality or indirectly bypassing the operating system to access the hardware for communications over the network.

Application programming interface (API) 306 allows the user of the system, an individual, or a software routine, to invoke system capabilities using a standard consistent interface without concern for how the particular functionality is implemented. Network access software 308 represents any software available for allowing the system to access a network. This access may be to a network, such as a local area network (LAN), wide area network (WAN), or the Internet. With the Internet, this software may include programs, such as Web browsers.

Application software 310 represents any number of software applications designed to react to data through the communications port to provide the desired functionality the user seeks, such as an instant messaging application. Applications at this level may include those necessary to handle data, video, graphics, photos, or text, which can be accessed by users of the Internet.

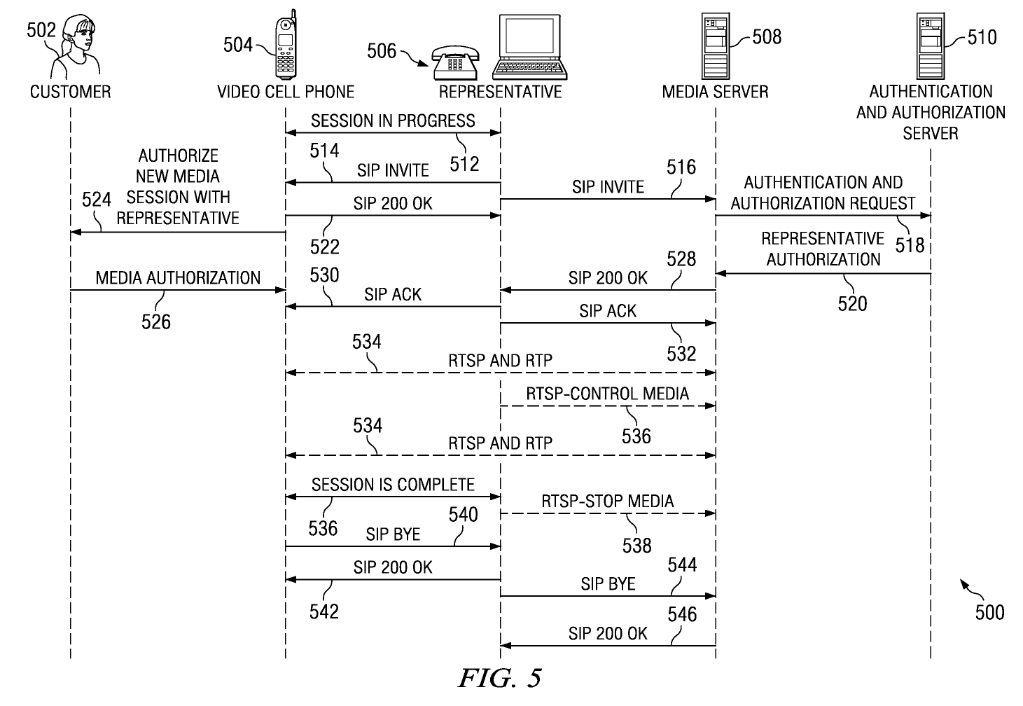

A user may own and use instant messaging on more than one device, and each device may have different operating systems and software applications installed. For example, a user may instant message on a Windows® notebook computer at multiple locations, an AIX® server in a lab, a Linux® desktop computer in the office, and a PalmOS® PDA. The illustrative embodiments may be implemented in any of the software components of FIG. 3. In particular, the illustrative embodiments may be implemented in application software 310 on a device, such as client 110 and server 104 of FIG. 1, and more particularly the discrete hardware components of FIG. 5.

Turning next to FIG. 4, a diagram illustrating components used in an instant messaging system is depicted in accordance with an illustrative embodiment. An instant messaging application may be a program application, such as application software 310 of FIG. 3. In the depicted example, instant messaging application 400 processes messages, such as message 402 received from users located on remote data processing systems. As messages are received, these messages are presented in dialog windows 404. Messages exchanged between instant messaging application 400 and an instant messaging application on a remote data processing system, form a conversation in these examples.

Additionally, dialog windows 404 provide an interface for user input to send messages to other users. Contact and control window 406 is presented by instant messaging application 400 to provide the user with a list of user names, as well as other information, such as, for example, identifying other users that are currently online. Contact and control window 406 also provide an interface to allow the user to set different preferences. For example, the user may set passwords required to access different names used in instant messaging sessions. Further, a user may employ contact and control window 406 to set other preferences, such as colors and fonts used in instant messaging application 400.

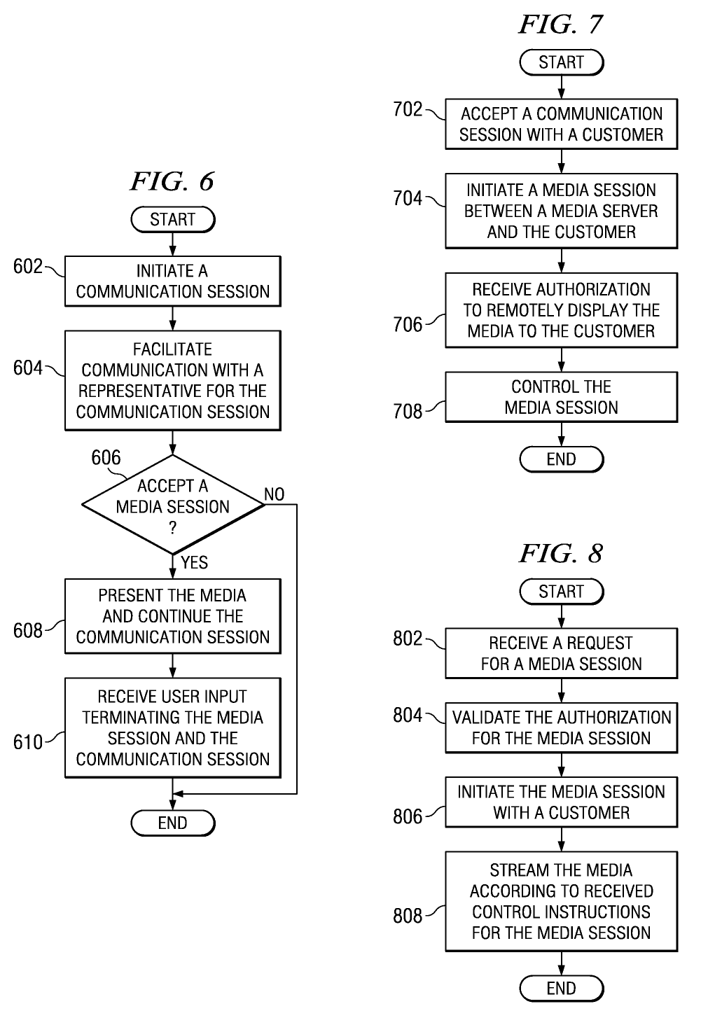

Further, the list of names presented by contact and control window 406 is stored in contact list 408 in these examples. Additional user names may be added or deleted from contact list 408. This contact list is employed in presenting the list of names within contact and control window 406. Additionally, the user may view the status of other users on contact and control window 406. This status may be, for example, available or busy. When the status is available, instant messaging application 400 will accept messages from another instant messaging application to start a new conversation. When the status of another user is busy, messages from instant messaging application 400 are not accepted by the other application for that user. The illustrative embodiments may be implemented using instant messaging application 400 to facilitate a communication session, media session, and additional interactions between devices, such as client 110 and server 104 of FIG. 1, and more particularly the discrete hardware components of FIG. 5. Instant messaging application 400 may be used to facilitate or implement the process of FIGS. 6-8.

The illustrative embodiments provide a computer implemented method, apparatus, and computer usable program code for providing remote access to information videos on demand during a voice call. The illustrative embodiments allow a displaying user to grant access to an audio or visual presentation referred to as media. The media may be, for example, a video feed, slide show, static pictures, interactive graphics, Flash presentation, audio, or any other media that may be useful for troubleshooting or solving customer's problems and concerns. The media may be accessed during a collaborative session which may involve a phone or data communication which may include a chat type session.

In many cases, a company or organization does not want to provide public access to the media. For example, the media may have portions with sensitive information or may be in a negative fashion. The sending or displaying user may control the presentation of the media to the user by showing specified portions of the media at a desired pace or according to a receiving user's needs. The displaying user may be a customer service representative or other company employee providing service to a customer or other user.

For example, the displaying user may initiate a video feed to a user receiving assistance in the middle of a conversation when it becomes apparent that available media would facilitate the conversation. Media that would facilitate the conversation refers to information that helps a user better understand a situation, problem, or information presented by the displaying user. For example, if a user is unable to identify which inputs should be used for connecting a plasma television, the displaying user may show a media visual indicating which inputs should be used. The user providing the video maintains control over the media by pushing, rewinding, fast forwarding, or skipping portions of the media as needed. As a result, the needs or questions of the receiving user are more easily resolved, saving time and more adequately solving the needs of customers.

The media may be displayed on any number of clients or user devices including computers, Internet Protocol (IP) televisions or phones, cell phones, and PDA's during a phone conference. In one illustrative embodiment, the media is streamed to the device upon which an ongoing phone or data conversation is occurring. For example, during a voice call over a voice telephony system, a video feed is streamed to a customer with a customer service representative controlling the flow and portions of the video streamed to the customer. In another embodiment, the media is transferred to another device as initiated or specified by the user. For example, a video may be streamed using the customer's instant messaging service and contact information.

The illustrative embodiments allow a sending or displaying user to proxy authorization so that media may be sent from a remote media server to the receiving user or customer in a controlled collaborative session.

FIG. 5 is a diagram illustrating an exemplary information flow for remotely providing media in accordance with the illustrative embodiments. FIG. 5 shows communication and communication timing in one applicable example. Remote media system 500 is a system used to send media to customer 502. The devices of remote media system 500 may be implemented in a configuration such as that of network data processing system 200 of FIG. 2. For example, video cell phone 504 used by customer 502 may be a device, such as client 110 of FIG. 1. Representative 506 may also be a client, such as client 112 of FIG. 1. Media server 508 and authentication and authorization server 510 may be servers, such as server 104 and 106 of FIG. 1, respectively. Video cell phone 504, representative 506, media server 508, and authentication and authorization server 510 may be interconnected via a network, such as network 102 of FIG. 1.

In this example, customer 502 is using video cell phone 504 to communicate with representative 506. Customer 502, the receiving user, has session in progress 512 with representative 506, the sending party. For example, customer 502 may call representative 506, requesting help for installing and setting up a wireless home network using hardware and software provided by a company associated with representative 506.

Next, representative 506 sends a session initiation protocol (SIP) invite 514 to video cell phone 504. Session initiation protocol is used for setting up communications sessions on the Internet, such as telephony, presence, events notification, and instant messaging. Session initiation protocol initiates call setup, routing, authentication, and other feature messages to endpoints or peer devices. SIP invite 514 indicates video cell phone 504 is being invited to participate in a call session and may be used to share the media with customer 502 via video cell phone 504.

Representative 506 also sends SIP invite 516 to media server 508. In one illustrative embodiment, media server 508 sends authentication and authorization request 518 to authentication and authorization server 510. An authentication and authorization request may be sent using lightweight directory access protocol (LDAP). Lightweight directory access protocol is a software protocol used to access a directory listing, enabling anyone to locate organizations, individuals, and other resources such as files and devices in a network, whether on the public Internet or on a corporate intranet. For example, authentication and authorization server 510 may determine whether representative 506 is allowed to access media requested from media server 508 by looking up authorizations and permissions for representative 506.

Authentication and authorization server 510 sends representative authorization 520 to media server 508 if authentication and authorization server 510 determines that representative 506 is authorized for the requested media. In parallel, video cell phone 504 may also authorize SIP invite 514 by sending a confirmation entitled SIP 200 OK 522. SIP 200 OK 522 indicates that video cell phone 504 has successfully responded to SIP invite 514. Next, video cell phone 504 requests that customer 502 authorize a new media session with representative 506. Authorize new media session with representative 524 ensures that representative 506 has media authorization 526 or the permission of customer 502 to send the media before the media is sent.

In response to SIP invite 516 and representative authorization 520, media server 508 sends SIP 200 OK 528 to representative 506. SIP 200 OK 528 is a verification response to initiate the session and functions in the same way as SIP 200 OK 522. Representative 506 sends SIP ACK 530 to video cell phone 504 and SIP ACK 532 to media server 508. SIP ACK 530 and 532 confirms that the client, video cell phone 504, and media server 508, respectively, have received a final response to an invite request.

Next, video cell phone 504 and media server 508 use real-time streaming protocol (RTSP) and real-time transport protocol (RTP) 534 to send the media. Real-time streaming protocol is a client/server communication protocol or method that simplifies the distribution of multimedia, such as audio, video, and other time-based media contents on the Internet. Real-time streaming protocol provides a method for choosing delivery mechanisms based upon real-time transport protocol (RTP), an Internet protocol that supports real-time transmission of streaming media, voice, and video.

In these examples, representative 506 maintains control over the media streamed to video cell phone 504 using RTSP control media 536. For example, the media may be a video that includes portions that are not intended for customer 502 to view. Representative 506 may block that portion of the video or images in the video or may skip them altogether as needed. In one embodiment, media control may be exercised by the representative using an enterprise application graphical user interface. The enterprise application may be an application, such as application software 310 of FIG. 3.

RTSP and RTP 534 are used to stream media until session is complete 536. As previously mentioned, the session may be a phone call, instant messaging session, or other communication. Next, representative 506 sends RTSP stop media 538 to media server 508. RTSP stop media 538 stops the media from being streamed using the real-time streaming protocol (RTSP). Next, video cell phone 504 sends SIP BYE 540 to representative 506. SIP BYE 540 is used by video cell phone 504 to terminate a call and may be sent by either the caller or the callee. Representative 506 sends SIP 200 OK 542 to confirm a successful response to SIP BYE 540. Representative 506 also sends SIP BYE 544 to media server 508. Media server 508 responds to the termination request with SIP 200 OK 546.

FIG. 6 is a flowchart of a process for accessing media in accordance with the illustrative embodiments. The process of FIG. 6 may be implemented by a customer using a device, such as customer 502 using video cell phone 504 of FIG. 5. The timing and interactions described in remote media system 500 of FIG. 5 may be applied to the process of FIG. 6.

The process begins with initiating a communication session (step 602). In step 602, this session is initiated through a user input, such as, for example, a customer beginning an instant messaging session with a customer service representative of a bank. The communication session may be a voice call or instant message session using an instant messaging application, such as instant messaging application 400 of FIG. 4. For example, the customer may have a request for a financial institution.

Next, the process facilitates communication with a representative for the communication session (step 604). For example, a customer may communicate requests, needs, or other requirements to a representative, such as representative 506 of FIG. 5. In one example, the representative may be associated with one or more businesses such as a bank. For example, the customer may request information regarding checks cashed by the customer in the month of July. Based on a predefined index, key word, problem recognition, log, or other search term or other recommendation, the representative may access media that may be useful for the present situation. The representative may have access to media that may be used to more efficiently address the customer's request. For example, the representative may have access to a media server, such as media server 508 of FIG. 5 that stores scanned copies of the checks.

The representative may verbally ask the customer for approval to stream a media session to the customer so that the representative may show the media to the user. In another embodiment, the representative may send a confirmation request requiring that the customer click an icon or verify personal information before the media is presented. Authorization for the representative to access the information may be required in order to stream the media to the customer. The authorization may include a password, digital security, or other authorization technique that provides a proxy authorization to stream the media to the customer.

In one illustrative embodiment, the customer may use a trust mechanism that automatically accepts media from specified sources. For example, the customer may accept instructions on how to use a personal digital assistant from the wireless service provider whenever a media session request is sent to the customer.

The communication session and media session may be sent to a single device, such as video cell phone 504 of FIG. 5. The communication session may occur on one device, and the media session may be streamed to an alternative device, such as a laptop, as specified by the customer.

Next, the process determines whether to accept a media session (step 606). The determination of step 606 may be made based on user input to an electronic invitation to initiate a media session. If the user input indicates that the media session should be rejected, the process terminates. In another embodiment, the customer's device may automatically accept the media session when received from the user.

If the process receives user input from the customer to accept the media session in step 606, the process presents the media and continues the communication session (step 608). In one embodiment, user input is received from a customer using a customer relation management (CRM) system to click a button on the customer relation management web graphical user interface accepting the media session. For example, the customer's checks for the month of July may be presented in a media slide show to the customer. By being able to actually view the checks, the customer's questions and concerns may be more quickly addressed, resulting in better time efficiency and more satisfied customers.

Because the media session and the communication session occur simultaneously, the representative may talk or chat with the user while the user views the media presentation in order to more effectively communicate thoughts, ideas, and information to the customer. The illustrative embodiments are particularly useful for customer service call centers that field different types of calls and may require different media for each customer. For example, a customer that has bought a children's tricycle may call a customer service representative on a home phone and have a presentation on how to assemble the bike streamed to an Internet protocol equipped television in the customer's home. As a result, the customer may be walked through one or more difficult steps in assembling the tricycle.

The illustrative embodiments may also be used for on-demand training as needed. For example, an electrician may call a power company in response to working on a meter the electrician has never seen. A sales engineer or customer service representative may stream an interactive presentation to the electrician in order to identify the model of the power meter and how the meter should be connected to the wiring of the house.

Next, the process receives user input terminating the media session and communication session (step 610) with the process terminating thereafter. Either the customer or the representative may terminate the communication session or media session at any time as needed. For example, a customer may close a chat application or hang up the phone.

FIG. 7 is a flowchart of a process for providing remote access to media in accordance with the illustrative embodiments. The process of FIG. 7 may be implemented by a representative, such as representative 506 of FIG. 5. For example, the representative may be a customer service person working on a computer or device, such as client 110 of FIG. 1. The process of FIG. 7 may be automated, such as an automatic answering system, or may be based on user input from an individual such as a customer service representative. The timing and interactions described in remote media system 500 of FIG. 5 may be applied to the process of FIG. 7. Additionally, the steps of FIG. 7 may occur in response to customer actions in a process such as that of FIG. 6.

The process begins with the representative accepting a communication session with a customer (step 702). Step 702 may occur in response to a step, such as step 602 of FIG. 6 when a customer initiates a communication session. During the communication session with the customer, such as customer 502 of FIG. 5, the representative may become aware that the media available to the representative may be useful to the customer. For example, key words typed during a chat session, voice recognition, or specified terms may be used to find useful media.

Next, the representative initiates a media session between a media server and the customer (step 704). The representative may initiate a media session with a media server, such as media server 508 of FIG. 5. The media server may be located locally or remotely with respect to the representative. In one embodiment, the representative may use an enterprise application graphical user interface to initiate the media session in step 704.

Next, the representative receives authorization to remotely display the media to the customer (step 706). In some cases, a representative must have authorization to access and deliver media to a customer. Authorization ensures that the representative is verified so that unnecessary or inappropriate media is not streamed to a customer. The representative or media server verifies that the representative has legitimate access to the media through an authentication server, such as authentication and authorization server 510 of FIG. 5. As a result, the customer may be presented with the necessary media based on the credentials and authorization of the representative. In another embodiment, the authentication process may be implemented by a software or security mechanism on the media server.

Next, the representative controls the media session (step 708) with the process terminating thereafter. The representative controls the media session in order to ensure that the customer is presented with the correct information at the appropriate time. For example, a slide show presentation of checks used by the customer in the month of July may need to be paused so that the customer can write down check information before proceeding to the next check.

FIG. 8 is a flowchart of a process for providing remote access to media in accordance with the illustrative embodiments. The process of FIG. 8 may be implemented by a media server, such as media server 508 of FIG. 5. The timing and interactions described in remote media system 500 of FIG. 5 may be applied to the process of FIG. 8. Additionally, the steps of FIG. 8 may occur in response to customer and representative actions in processes such as those of FIG. 6 and FIG. 7.

The process of FIG. 8 begins with the media server receiving a request for a media session (step 802). The request may be for media specified by a representative in a step, such as step 704 of FIG. 7. Next, the media server validates the authorization for the media session (step 804). For example, the media server may validate credentials of the representative by means of a password, digital authentication, security software, or other authentication and verification process. In one embodiment, the media server may send a request to an authentication server, such as authentication and authorization server 510 of FIG. 5.

Next, the media server initiates the media session with the customer (step 806). For example, the media session may be initiated by sending a media session invitation or by beginning to stream the media directly to a client-specified device. The media server may initiate the media session, but the media session will not continue if not accepted by a customer using a device, such as customer 502 and video cell phone 504 of FIG. 5. The media session may be accepted in a step, such as step 606 of FIG. 6

Next, the media server streams the media according to received control instructions for the media session (step 808) with the process terminating thereafter. The media is streamed as controlled by a representative, such as representative 506 of FIG. 5. As a result, the information provided to an end-user or customer is shown only as approved by the representative. Controlled streaming is especially useful when a company may have rules or other stipulations specifying what information may be shown to customers. The media server has no control over the termination of the media session. The media session is terminated by input from the customer or representative.

Thus, the illustrative embodiments provide a computer implemented method, apparatus, and computer usable program code for providing remote access to information videos on demand during a voice call. Illustrative embodiments allow a sending user to grant access to media. The sending user is able to use a specified proxy authorization so that media may be sent from a remote media server to the receiving user in a controlled collaborative session. As a result, a customer may receive media required for any number of problems during a communication session with a customer service representative for more efficiently meeting the needs of the customer.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for providing media, the computer implemented method comprising:
responsive to a communication session with a user, determining whether providing the media would aid in providing information to the user;
responsive to a determination that providing the media would aid in providing information to the user, authorizing sending of the media to the user based on an authorization of a representative; and
controlling a flow of the media sent to the user from a media server after the media has been authorized.

2. The computer implemented method of claim 1, further comprising:
responsive to the determination that providing the media would aid in providing information to the user, sending a media session invitation to the user.

3. The computer implemented method of claim 2, further comprising:
responsive to the user accepting the media session invitation, streaming the media to the user from the media server.

4. The computer implemented method of claim 1, wherein the communication session is any of a voice session, instant messaging session, and data communication session.

5. The computer implemented method of claim 1, further comprising:
recommending the media to the representative based on the communication session.

6. The computer implemented method of claim 1, wherein the authorization step is performed by an authentication and authorization server.

7. The computer implemented method of claim 1, wherein the authorization step is performed based on credentials of the representative.

8. The computer implemented method of claim 1, wherein the media is any of a video, static pictures, interactive graphics, and Flash presentation.

9. The computer implemented method of claim 1, wherein the representative controls the flow of the media to the user using an enterprise application graphical user interface.

10. The computer implemented method of claim 1, wherein the media is streamed in a media session, and wherein the communication session and the media session are integrated to stream the media using the communication session.

11. The computer implemented method of claim 1, wherein the communication session and the media session are received on different devices accessed by the user.

12. A system comprising:
a receiving client wherein the receiving client initiates a communication session with a sending client operably connected to the receiving client;
a media server operably connected to the receiving client and the sending client, wherein the sending client sends a media session invitation to the receiving client in response to a determination that providing media would aid in providing information to the receiving client, and authorizes the media to be streamed to the receiving client, wherein the media server streams the media to the receiving client in response to the receiving client accepting the media session invitation, wherein the sending client controls a flow of the media sent to the receiving client from the media server.

13. The system of claim 12, wherein the media server validates credentials of the sending client to authorize the media to be streamed to the receiving client by verifying credentials with an authentication and authorization server operably connected to the media server.

14. The system of claim 12, wherein the receiving client is an Internet protocol enabled device.

15. The system of claim 12, wherein a user using the receiving client accepts the media session invitation by sending a confirmation to the sending client.

16. The system of claim 12, wherein the communication session occurs on a first receiving client and the media session occurs on a second receiving client.

17. The system of claim 12, wherein the media is any of a video, static pictures, interactive graphics, and Flash presentation.

18. A computer program product comprising a computer usable medium including computer usable program code for providing media, the computer program product comprising:
computer usable program code responsive to a communication session with a user, for determining whether providing the media would aid in providing information to the user;
computer usable program code responsive to a determination that providing the media would aid in providing information to the user, for authorizing sending of the media to the user based on an authorization of a representative; and
computer usable program code for controlling a flow of the media sent to the user from the media server after the media has been authorized.

19. The computer program product of claim 18, comprising:
computer usable program code for recommending the media to the representative based on the communication session
computer usable program code responsive to the determination that providing the media would aid in providing information to the user, for sending a media session invitation to the user; and
computer usable program code responsive to the user accepting the media session invitation, for streaming the media to the user from the media server.

20. The computer program product of claim 18, wherein the authorization is credentials of the representative, wherein the communication session is any of a voice session, instant messaging session, and data communication session, and wherein the media is any of a video, static pictures, interactive graphics, and Flash presentation.
